(19) United States
(12) Patent Application Publication
(10) Pub. No.: US 2008/0106981 A1
(43) Pub. Date: May 8, 2008

(54) Multi-layer optical disc, optical-disc drive apparatus, and method of making decision on currently-accessed recording layer in multi-layer optical disc

(75) Inventors: Toshio Kuroiwa, Kanagawa-ken (JP); Masayoshi Nishitani, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/907,350

(22) Filed: Oct. 11, 2007

(30) Foreign Application Priority Data
Nov. 2, 2006 (JP) 2006-298388

(51) Int. Cl. G11B 7/00

(52) U.S. Cl. 369/44.13

(57) ABSTRACT

An optical disc has a laminate of recording layers. The recording layers have tracks respectively. The tracks wobble in accordance with wobbling signals respectively, and thereby indicate the wobbling signals respectively. The wobbling signals result from modulation of bit streams formed by sequences of concatenated fixed-length words of a predetermined self-synchronizable code. Each of the words is composed of check point bits and information bits. The check point bits in each word represent a sync position and a layer identification information piece selected from different layer identification information pieces assigned to the recording layers respectively for indicating which of the recording layers the related word is assigned to. The information bits represent address information. A drive apparatus for a multi-layer optical disc, and a method of making a decision on a currently-accessed recording layer in a multi-layer optical disc are also disclosed.

### BACKGROUND OF THE INVENTION

1. Field of the Invention

This invention relates to a multi-layer optical disc, that is, an optical disc having multiple recording layers. In addition, this invention relates to an apparatus for driving a multi-layer optical disc. Furthermore, this invention relates to a method of making a decision on a currently-accessed recording layer in a multi-layer optical disc.

2. Description of the Related Art

Japanese patent application publication number 2003-36544 discloses an information recording medium formed with a recording track groove which has wobbling portions and non-wobbling portions. Each wobbling portion is assigned to a data bit of “1” while each non-wobbling portion is assigned to a data bit of “0”. The data bits indicate on-medium address information.

Japanese patent application publication number 2000-293889 discloses a multi-layer optical disc designed to enable an optical-disc drive apparatus to easily discriminate recording layers from each other. The optical disc in Japanese application 2000-293889 has a laminate of first and second recording layers. First address marks are placed in the first recording layer. The first address marks are the same. Each of the first address marks is designed to cause a signal reproduced therefrom to be of a first pattern. Second address marks different from the first address marks are placed in the second recording layer. The second address marks are the same. Each of the second address marks is designed to cause a signal reproduced therefrom to be of a second pattern different from the first pattern. During the recording of data on or the reproduction of data from one of the first and second recording layers, the optical-disc drive apparatus reproduces a signal from an address mark in the currently-accessed recording layer. The optical-disc drive apparatus decides whether the reproduced signal is of the first pattern or the second pattern. Thereby, the optical-disc drive apparatus detects which of the first and second recording layers is currently accessed.

In the optical disc of Japanese application 2000-293889, the recording tracks on the first and second recording layers are divided into sectors each having an address mark area formed with a corresponding address mark. The first and second address marks are equal in pattern formed by an arrangement of pits. The first and second address marks are opposite in physical concave/convex so that the polarity of return light caused by reflection of forward light at the first address mark and the polarity of return light caused by reflection of the forward light at the second address mark will be opposite. The optical-disc drive apparatus converts the return light caused by reflection of the forward light at the first address mark or the second address mark into a signal reproduced therefrom.

Japanese application 2000-293889 does not teach that the first and second address marks are recorded on the optical disc as portions of wobbles of the recording tracks on the first and second recording layers.

### SUMMARY OF THE INVENTION

It is a first object of this invention to provide a multi-layer optical disc which enables an optical-disc drive apparatus to quickly decide which of recording layers is currently accessed.

It is a second object of this invention to provide an optical-disc drive apparatus capable of quickly deciding which of recording layers is currently accessed in a multi-layer optical disc.

It is a third object of this invention to provide a method of quickly deciding which of recording layers is currently accessed in a multi-layer optical disc.

A first aspect of this invention provides an optical disc having a plurality of recording layers arranged in a laminate in a thickness-wise direction of the disc. The recording layers have tracks respectively. The tracks wobble in accordance with wobbling signals respectively and thereby indicate the wobbling signals respectively. The wobbling signals result from modulation of bit streams formed by sequences of concatenated fixed-length words of a predetermined self-synchronizable code. Each of the words is composed of check point bits and information bits. The check point bits represent a sync position and a layer identification information piece selected from different layer identification information pieces assigned to the recording layers respectively for indicating which of the recording layers the related word is assigned to. The information bits represent address information.

A second aspect of this invention is based on the first aspect thereof, and provides an optical disc wherein the predetermined self-synchronizable code is a comma-free code of a prefix type.

A third aspect of this invention provides a drive apparatus for an optical disc having a plurality of recording layers arranged in a laminate in a thickness-wise direction of the disc. The recording layers have tracks respectively. The tracks wobble in accordance with wobbling signals respectively and thereby indicate the wobbling signals respectively. The wobbling signals result from modulation of bit streams formed by sequences of concatenated fixed-length words of a predetermined self-synchronizable code. Each of the words is composed of bits including check point bits which represent a sync position and also a layer identification information piece selected from different layer identification information pieces assigned to the recording layers respectively for indicating which of the recording layers the related word is assigned to. The drive apparatus comprises an optical pickup for applying a forward laser beam to the optical disc and focusing the forward laser beam on one of the recording layers in the optical disc, and for receiving a return laser beam caused by reflection of the forward laser beam at the optical disc and converting the received return laser beam into an electric signal; a demodulator for demodulating a wobbling signal in the electric signal into a reproduced bit stream formed by a sequence of concatenated fixed-length words of the predetermined self-synchronizable code; first means for deciding a layer identification information piece represented by check point bits in the reproduced bit stream; and second means for determining which of the recording layers the forward laser beam is currently focused on by referring to the layer identification information piece decided by the first means.

A fourth aspect of this invention is based on the third aspect thereof, and provides a drive apparatus wherein the bits constituting each of the words include information bits representing address information, and further comprising third means for detecting information bits in the reproduced bit stream, and fourth means for recovering address information from the information bits detected by the third means.

A fifth aspect of this invention is based on the third aspect thereof, and provides a drive apparatus wherein the predetermined self-synchronizable code is a comma-free code of a prefix type.

A sixth aspect of this invention provides a method of making a decision on a currently-accessed recording layer in an optical disc having a plurality of recording layers arranged in a laminate in a thickness-wise direction of the disc. The recording layers have tracks respectively. The tracks wobble in accordance with wobbling signals respectively and thereby indicate the wobbling signals respectively. The wobbling signals result from modulation of bit streams formed by sequences of concatenated fixed-length words of a predetermined self-synchronizable code. Each of the words is composed of bits including check point bits which represent a sync position and also a layer identification information piece selected from different layer identification information pieces assigned to the recording layers respectively for indicating which of the recording layers the related word is assigned to. The method comprises the steps of applying a forward laser beam to the optical disc and focusing the forward laser beam on one of the recording layers in the optical disc; receiving a return laser beam caused by reflection of the forward laser beam at the optical disc and converting the received return laser beam into an electric signal; demodulating a wobbling signal in the electric signal into a reproduced bit stream formed by a sequence of concatenated fixed-length words of the predetermined self-synchronizable code; comparing a periodically-updated current portion of the reproduced bit stream with the different layer identification information pieces to count, for each of the different layer identification information pieces, a number of times the current portion of the reproduced bit stream is equal to the present layer identification information piece; detecting a greatest one among the count numbers for the different layer identification information pieces respectively, the greatest one being greater than a second greatest one by at least a predetermined value; and deciding that the recording layer corresponding to the detected greatest one among the count numbers is the recording layer on which the forward laser beam is currently focused on.

A seventh aspect of this invention is based on the sixth aspect thereof, and provides a method wherein the predetermined self-synchronizable code is a comma-free code of a prefix type.

This invention has advantages mentioned hereafter. A wobbling signal in a reproduced signal is demodulated into a reproduced bit stream formed by a sequence of concatenated fixed-length words of the predetermined self-synchronizable code. A layer identification information piece represented by check point bits in the reproduced bit stream is decided. For this decision, there may be a step of comparing an updatable current portion of the reproduced bit stream with the different layer identification information pieces assigned to the recording layers respectively. A determination is made as to which of the recording layers the forward laser beam is currently focused on by referring to the decided layer identification information piece. Thus, without recovering address information from the reproduced bit stream, the forgoing determination can be made. Accordingly, it is possible to quickly determine which of the recording layers the forward laser beam is currently focused on.

An updatable current portion of the reproduced bit stream is repetitively compared with the different layer identification information pieces to count, for each of the different layer identification information pieces, a number of times an updatable current portion of the reproduced bit stream is equal to the present layer identification information piece. A greatest one is detected among the count numbers for the different layer identification information pieces respectively. The greatest one is greater than a second greatest one by at least a predetermined value. It is decided that the recording layer corresponding to the detected greatest one among the count numbers is the recording layer on which the forward laser beam is currently focused on. Since the greatest one is greater than the second greatest one by at least the predetermined value, the determination as to which of the recording layers the forward laser beam is currently focused on is reliable even in the event that temporary demodulation errors occur.

### BRIEF DESCRIPTION OF THE DRAWINGS

FIG. 1 is a perspective view of a portion of a first related-art optical disc.

FIG. 2 is a diagrammatic section view of a portion of a second related-art optical disc.

FIG. 3 is a diagrammatic section view of a portion of an optical disc according to a first embodiment of this invention.

FIG. 4 is a perspective view of a portion of the optical disc in FIG. 3.

FIG. 5 is a diagram showing an example of the structure of one code word for address information recorded on the optical disc in FIGS. 3 and 4.

FIG. 6 is a diagram of a first example of three successive CFC (comma-free code) words.

FIG. 7 is a diagram of a second example of three successive CFC words.

FIG. 8 is a diagrammatic plan view showing the relation between the logic states of recorded bits and the wobbling shape of a portion of a track groove in the optical disc in FIGS. 3 and 4.

FIG. 9 is a block diagram of an optical-disc drive apparatus in the first embodiment of this invention.

FIG. 10 is a block diagram of a sync detection circuit in FIG. 9.

FIG. 11 is a block diagram of a computer within a sync detection circuit in a second embodiment of this invention.

FIG. 12 is a flowchart of a first segment of a control program for the computer in FIG. 11.

FIG. 13 is a flowchart of a second segment of the control program for the computer in FIG. 11.

### DETAILED DESCRIPTION OF THE INVENTION

Related-art optical discs and related-art apparatuses will be explained below for a better understanding of this invention.

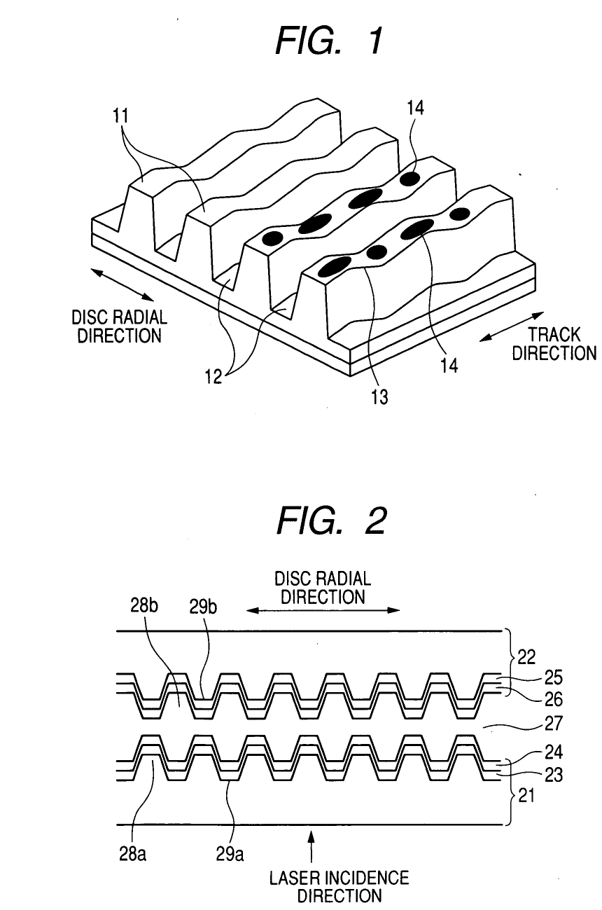

FIG. 1 shows a portion of a first related-art optical disc which is of a recordable type. The related-art optical disc in FIG. 1 has a recording track composed of a spiral groove 11 and lands 12 extending along the opposite sides of the groove 11.

As viewed in a radial direction of the disc, the distance between the central lines in neighboring portions of the groove 11 is constant. In other words, the track pitch is constant.

The walls defining the sides of the groove 11 wobble in radial directions of the disc, that is, directions perpendicular to the longitudinal direction of the groove 11. Accordingly, the groove 11 or the recording track has a wobble 13. The frequency of the wobble 13 is constant. The wobble 13 has a small amplitude. During the manufacture of the disc, the wobble 13 is formed.

During the recording of data on the related-art optical disc in FIG. 1, a spot of a laser beam emitted from an optical pickup (not shown) is guided along the groove 11 while forming recorded marks 14 therein.

A related-art optical-disc drive apparatus senses the shape of the wobble 13 while rotating the disc. The apparatus generates a reference clock signal in accordance with the sensed shape of the wobble 13. The apparatus forms recorded marks 14 in response to the reference clock signal so that the arrangement of the recorded marks 14 will be in a fixed relation with the conditions of the wobble 13, and that the recorded marks 14 will be distributed at a desired recording density.

FIG. 2 shows a portion of a second related-art optical disc which has a laminate of two recording layers. The related-art optical disc in FIG. 2 has a first substrate 21 and a second substrate 22. Each of the first and second substrates 21 and 22 has a thickness of about 0.6 mm. The first and second substrates 21 and 22 are basically transparent.

As shown in FIG. 2, a land 28a and a groove 29a extend in the first substrate 21. A land 28b and a groove 29b extend in the second substrate 22. The first and second substrates 21 and 22 are bonded together by an adhesive layer 27 located therebetween. The related-art optical disc in FIG. 2 is about 1.2 mm in thickness.

A first recording layer 23 to be formed with recorded marks extends on the first substrate 21. A semitransparent reflective film 24 is superposed on the first recording layer 23. A laminate of a reflective film 25 and a second recording layer 26 extends on the second substrate 22. The second recording layer 26 is closer to the first substrate 21 than the reflective film 25 is. The semitransparent reflective film 24 on the first substrate 21 and the second recording layer 26 on the second substrate 22 are bonded together by the adhesive layer 27 while being opposed to each other.

Data can be recorded on or reproduced from the first and second recording layers 23 and 26. The recording of data on the first recording layer 23 and the recording of data on the second recording layer 26 can be independent of each other. The reproduction of data from the first recording layer 23 and the reproduction of data from the second recording layer 26 can be independent of each other. During the recording of data on the first recording layer 23 or the reproduction of data therefrom, a laser beam is focused into a spot on the first recording layer 23. During the recording of data on the second recording layer 26 or the reproduction of data therefrom, the laser beam is focused into a spot on the second recording layer 26.

A third related-art optical disc is a DVD-RAM. Pre-recorded on-disc address information is stored in the DVD-RAM. By reproducing the on-disc address information from the DVD-RAM and referring to the reproduced on-disc address information, it is possible to detect the position (address) of a currently-accessed portion of a recording track on the DVD-RAM. The main recording area of the recording track is cut into separate data regions between which header regions (header fields) are located. Embossed pit trains (called headers) representative of on-disc address information are formed in the header regions in a pre-recording procedure during the manufacture of the DVD-RAM. The header regions can not be used for data recording. Therefore, the header regions cause a reduction in the usable capacity of the DVD-RAM.

A fourth related-art optical disc has a recording track which wobbles to indicate on-disc address information. The wobbling hardly causes a reduction in the usable capacity of the disc.

A related-art drive apparatus for the related-art optical disc in FIG. 2 implements the recording of data on the disc and the reproduction of data therefrom. Before the implementation of the data recording or the data reproduction, the apparatus is required to confirm that a currently-accessed recording layer is desired one of the first and second recording layers 23 and 26.

In the related-art optical disc of FIG. 2, the depth positions of the first and second recording layers 23 and 26 are different since the adhesive layer 27 extends between the first and second recording layers 23 and 26. The first recording layer 23 is closer to an optical pickup (not shown) than the second recording layer 26 is. In the case where a forward laser beam emitted from the optical pickup is focused on the first recording layer 23, the forward laser beam is reflected at the semitransparent reflective film 24 so that a return laser beam is caused. In the case where the forward laser beam is focused on the second recording layer 26, the forward laser beam passes through the semitransparent reflective film 24 before reaching the second recording layer 26. Then, the forward laser beam is reflected at the reflective film 25 so that a return laser beam is caused. The return laser beam passes through the semitransparent reflective film 24 before reaching the optical pickup and hence being sensed by the optical pickup. Accordingly, the sensed return laser beam originating from the forward laser beam focused on the second recording layer 26 is lower in intensity than that originating from the forward laser beam focused on the first recording layer 23. It is conceivable to decide which of the first and second recording layers 23 and 26 is currently accessed on the basis of the intensity of the sensed return laser beam. The result of this decision is thought to be low in reliability.

A fifth related-art optical disc has first and second recording layers formed with respective recording tracks on which information representative of address values (that is, on-disc address information) is pre-recorded. In the disc, a range of address values for the recording track on the first recording layer and that for the recording track on the second recording layer are set independent of each other.

A sixth related-art optical disc has first and second recording layers formed with respective recording tracks on which information representative of address values (that is, on-disc address information) is pre-recorded. Layer ID information for discriminating the first and second recording layers from each other is recorded on the recording tracks of the disc in addition to the information representative of the address values.

A related-art drive apparatus for the fifth related-art optical disc or the sixth related-art optical disc operates as follows. The apparatus focuses a laser beam on a recording layer of the disc and controls the laser beam to implement tracking with respect to the recording track on the recording layer, and thereby reads on-disc address information and layer ID information from the recording layer. Thereafter, the apparatus decides whether or not the currently-accessed recording layer is desired one. In these operation steps, the apparatus is required to read all on-disc address information and layer ID information from a long portion of the recording track, subject the read on-disc address information and layer ID information to error correction, and wait for the completion of the error correction. These requirements increase an access time spent by the apparatus.

A seventh related-art optical disc is disclosed in Japanese patent application publication number 2000-293889. As previously mentioned, the disc has a laminate of first and second recording layers. First address marks are placed in the first recording layer. Each of the first address marks is designed to cause a signal reproduced therefrom to be of a first pattern. Second address marks different from the first address marks are placed in the second recording layer. Each of the second address marks is designed to cause a signal reproduced therefrom to be of a second pattern different from the first pattern. The first address marks and the second address marks allow a decision as to which of the first and second layers is currently accessed. In the disc, the recording tracks on the first and second recording layers are divided into sectors each having an address mark area formed with a corresponding address mark. The first and second address marks are equal in pattern formed by an arrangement of pits. The first and second address marks are opposite in physical concave/convex so that the polarity of return light caused by reflection of forward light at the first address mark and the polarity of return light caused by reflection of the forward light at the second address mark will be opposite.

### FIRST EMBODIMENT

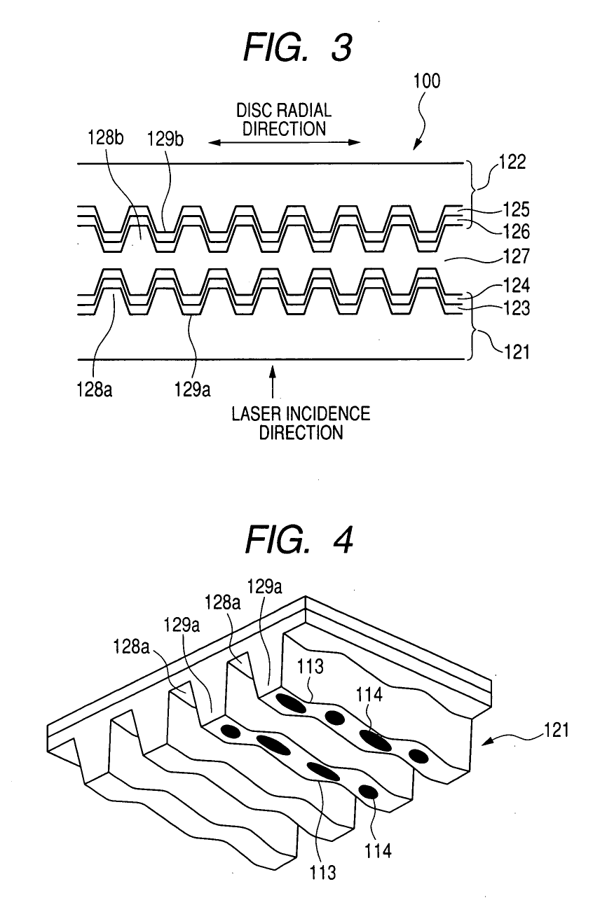

FIG. 3 shows a portion of an optical disc 100 according to a first embodiment of this invention. The optical disc 100 is of a two-layer type, and has a laminate of two recording layers as viewed in a thickness-wise direction of the disc 100.

With reference to FIG. 3, the optical disc 100 has a first substrate 121 and a second substrate 122. Each of the first and second substrates 121 and 122 has a thickness of about 0.6 mm. The first and second substrates 121 and 122 are basically transparent.

A land 128a and a groove 129a spirally extend in the first substrate 121. A land 128b and a groove 129b spirally extend in the second substrate 122. The grooves 129a and 129b substantially have a predetermined width. The first and second substrates 121 and 122 are bonded together by an adhesive layer 127 located therebetween. The optical disc 100 is about 1.2 mm in thickness.

A first recording layer 123 to be formed with recorded marks 114 extends on the first substrate 121. The first recording layer 123 has the land 128a and the groove 129a. A semitransparent reflective film 124 is superposed on the first recording layer 123. A laminate of a reflective film 125 and a second recording layer 126 extends on the second substrate 122. The second recording layer 126 is closer to the first substrate 121 than the reflective film 125 is. The second recording layer 126 has the land 128b and the groove 129b. The semitransparent reflective film 124 on the first substrate 121 and the second recording layer 126 on the second substrate 22 are bonded together by the adhesive layer 127 while being opposed to each other.

Data can be recorded on or reproduced from the first and second recording layers 123 and 126. The recording of data on the first recording layer 123 and the recording of data on the second recording layer 126 can be independent of each other. The reproduction of data from the first recording layer 123 and the reproduction of data from the second recording layer 126 can be independent of each other. During the recording of data on the first recording layer 123 or the reproduction of data therefrom, a laser beam is focused into a spot on the first recording layer 123. During the recording of data on the second recording layer 126 or the reproduction of data therefrom, the laser beam is focused into a spot on the second recording layer 126. The first recording layer 123 is closer to an optical pickup (not shown in FIG. 3) than the second recording layer 126 is.

With reference to FIG. 4, the spiral groove 129a and the spiral land 128a in the first substrate 121 constitute a spirally-extending recording track. In FIG. 4, a portion of the groove 129a, and portions of the land 128a which extend along the opposite sides of the portion of the groove 129a constitute a portion of the recording track.

As viewed in a radial direction of the optical disc 100, the distance between the central lines in neighboring portions of the groove 129a is constant. In other words, the track pitch is constant.

The walls defining the sides of the groove 129a wobble in radial directions of the optical disc 100, that is, directions perpendicular to the longitudinal direction of the groove 129a. Accordingly, the groove 129a or the recording track has a wobble 113. The frequency of the wobble 113 is modulated to carry address information. The wobble 113 has a predetermined small amplitude. During the manufacture of the optical disc 100, the wobble 113 is formed in a known pre-recording procedure.

During the recording of data on the first recording layer 123 in the optical disc 100, a spot of a laser beam emitted from an optical pickup (not shown in FIG. 4) is guided along the groove 129a while forming recorded marks 114 therein.

The spiral groove 129b and the spiral land 128b in the second substrate 122 constitute a spirally-extending recording track as the spiral groove 129a and the spiral land 128a in the first substrate 121 do. The groove 129b wobbles as the groove 129a does.

The wobble 113 of each of the grooves 129a and 129b is frequency-modulated with address information and layer identification information which are encoded for the purpose of self-synchronization using, for example, a comma-free code of a prefix type. In other words, the address information is recorded on the optical disc 100 as the wobble 113. Thus, the address information is represented by the wobble 113. The optical disc 100 does not have header regions (header fields). The grooves 129a and 129b spirally extend on the recording planes of the optical disc 100. The track pitch related to the recording tracks inclusive of the grooves 129a and 129b is constant.

The address information recorded on the optical disc 100 as the wobble 113 is formed by data representing at least one of (1) an absolute address with respect to the whole recording surface of the optical disc 100, (2) a relative address assigned to a partial region in the optical disc 100, (3) a track order number (a track ID number), (4) a sector order number (a sector ID number), (5) a frame order number (a frame ID number), (6) a field order number (a field ID number), (7) time information, (8) an error correction code, (9) category information about the optical disc 100, (10) a desired power of a recording laser beam, and (11) a desired rotational speed of the optical disc 100. The data is of a binary code including a BCD code, a Gray code, or another code. The data results from conversion of an original decimal or hexadecimal digital signal into a binary-code signal.

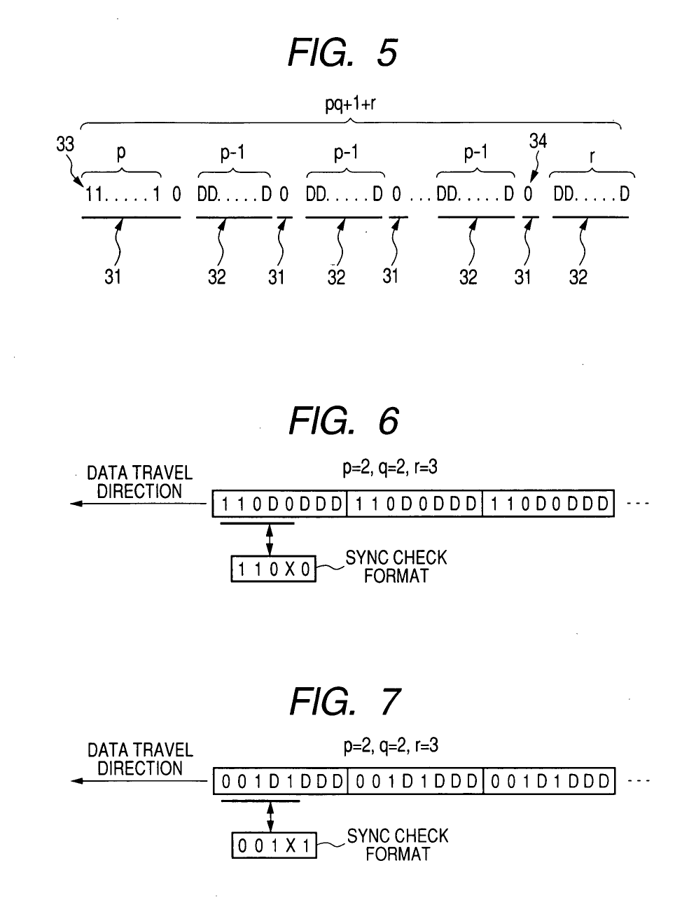

FIG. 5 shows an example of the structure of one word of a predetermined code for the address information recorded on the optical disc 100. The predetermined code is a self-synchronizable code. Preferably, the predetermined code is a comma-free code (CFC) of a prefix type. The feature of the CFC is as follows. By observing a given-length bit pattern in a bit stream formed by a succession of concatenated code words of the CFC, it is possible to detect the boundaries among the code words and hence to acquire word-based synchronization. Code words of the CFC used for the address information recorded on the optical disc 100 have a fixed bit length.

With reference to FIG. 5, one word of the CFC has a sequence of “p·q+1+r” bits which are check point bits 31 and information bits 32. The check point bits 31 represent a word-based sync position. The check point bits are prefix ones and intermediate ones. Specifically, a succession of prefix check point bits 31 occupies a head of one CFC word. Each of the prefix check point bits 31 is in a logic state of “1”. The total number of the prefix check point bits 31 is equal to a predetermined value “p”. Intermediate check point bits 31 and groups of successive information bits 32 occupy the remaining portion of the CFC word which follows the head. Each of the intermediate check point bits 31 is in a logic state of “0”. The information bits 32 represent an information piece assigned to the CFC word. Each of the information bits 32 is in a logic state D of “1” or “0” depending on a corresponding fragment of the information piece. The first intermediate check point bit 31 is located between the succession of the prefix check point bits 31 and the first group of information bits 32. Each of the second and later intermediate check point bits 31 is placed between adjacent ones of the groups of information bits 32. The total number of the intermediate check point bits 31 is equal to a predetermined value “q”. The number of information bits 32 in each of the groups except the last one is equal to a predetermined value “p−1”. The number of information bits 32 in the last group is equal to a predetermined value “r”. The total number of the prefix check point bits 31 and the intermediate check point bits 31 is equal to a predetermined value “d” (d=p+q). The total number of the information bits 32 is equal to a predetermined value “k” (k=(p−1)·(q−1)+r).

For acquiring synchronization with CFC words, the predetermined values “r”, “p”, and “q” are required to satisfy the following relation.

r≦p·q (1)

This is confirmed by considering a case where the value “r” is equal to the value “p·q”, and the information bits in the last group in the CFC word are the same in logic state as the successive bits in the CFC word which starts from the first prefix check point bit 31. In this case, the last group of information bits 32 in the CFC word is followed by a bit of “1”, that is, the first prefix check bit 31 in the next CFC word which is denoted by the reference numeral “33” in FIG. 5. This bit of “1” is at the (p·q+1)-th place measured from the head of the last group of information bits 32. On the other hand, a bit at the (p·q+1)-th place measured from the head of the CFC word is an intermediate check point bit 31 denoted by the reference numeral “34” in FIG. 5, and is hence in a logic state of “0”. Accordingly, by checking the bit at the (p·q+1)-th place, a succession of information bits in the last group in the CFC word which is the same in logic state as the succession of prefix check point bits 31 is prevented from being recognized to be the succession of prefix check point bits 31. Thus, it is possible to detect the boundary between the last group of information bits 32 in the CFC word and the succession of prefix check point bits 31 in the next CFC word. Therefore, it is possible to acquire word-based synchronization.

It should be noted that each of the prefix check point bits 31 may be in a logic state of “0”. In this case, each of the intermediate check point bits 31 is in a logic state of “1”.

FIG. 6 shows a first example of three successive CFC words in which the predetermined values “p”, “q”, and “r” are equal to 2, 2, and 3, respectively. With reference to FIG. 6, two successive bits of “1”, which are prefix check point bits, occupy a head of each CFC word. A bit of “0”, which is a first intermediate check point bit, follows the prefix check point bits in each CFC word. A first information bit D, a bit of “0” (a second intermediate check point bit), a second information bit D, a third information bit D, and a fourth information bit D successively follow the first intermediate check point bit in each CFC word. Accordingly, there are four information bits D in each CFC word. A bit pattern used for a synchronization check is expressed as a bit sequence of “110X1”, where X denotes an information bit, that is, a bit unrelated to the synchronization check. A bit sequence (a bit pattern) of “110X0” is detected in a bit stream formed by a succession of concatenated CFC words. Detection of a bit sequence of “110X0” means detection of the boundary between two successive CFC words. By referring to the detected bit sequence of “110X0”, it is possible to identify or detect information bits D in a related CFC word and later CFC words. Thus, it is possible to recover information represented by the identified information bits D. A bit pattern of “110X0” is also called a synchronization check format.

FIG. 7 shows a second example of three successive CFC words in which the predetermined values “p”, “q”, and “r” are equal to 2, 2, and 3, respectively. With reference to FIG. 7, two successive bits of “0”, which are prefix check point bits, occupy a head of each CFC word. A bit of “1”, which is a first intermediate check point bit, follows the prefix check point bits in each CFC word. A first information bit D, a bit of “1” (a second intermediate check point bit), a second information bit D, a third information bit D, and a fourth information bit D successively follow the first intermediate check point bit in each CFC word. Accordingly, there are four information bits D in each CFC word. A bit pattern used for a synchronization check is expressed as a bit sequence of “001X1”, where X denotes an information bit, that is, a bit unrelated to the synchronization check. A bit sequence (a bit pattern) of “001X1” is detected in a bit stream formed by a succession of concatenated CFC words. Detection of a bit sequence of “001X1” means detection of the boundary between two successive CFC words. By referring to the detected bit sequence of “001X1”, it is possible to identify or detect information bits D in a related CFC word and later CFC words. Thus, it is possible to recover information represented by the identified information bits D. A bit pattern of “001X1” is also called a synchronization check format.

A sequence of information bits D representing the address information is prepared. The sequence of information bits D is encoded into a stream of CFC words. The stream of CFC words is subjected to modulation for recording so that a modulation-resultant signal is generated. During a known pre-recording procedure, wobbles 113 are formed in an optical disc 100 in accordance with the modulation-result signal. Accordingly, the modulation-resultant signal is recorded on the optical disc 100.

Specifically, the address information is composed of first and second halves for the first and second recording layers 123 and 126 respectively. A first sequence of information bits D representing the first half of the address information is prepared. A second sequence of information bits D representing the second half of the address information is also prepared. The first sequence of information bits D is encoded into a first succession of CFC words accorded with predetermined one of a synchronization check format of “110X0” and a synchronization check format of “001X1”. Specifically, the first sequence of information bits D is converted into a first succession of CFC words each having predetermined one of a synchronization check format of “110X0” and a synchronization check format of “001X1”. The second sequence of information bits D is encoded into a second succession of CFC words accorded with the other of a synchronization check format of “110X0” and a synchronization check format of “001X1”. Specifically, the second sequence of information bits D is converted into a second succession of CFC words each having the other of a synchronization check format of “110X0” and a synchronization check format of “001X1”. The first succession of CFC words takes the form of a first bit stream. The first bit stream (the first succession of CFC words) is subjected to modulation for recording so that a first modulation-resultant signal is generated. The second succession of CFC words takes the form of a second bit stream. The second bit stream (the second succession of CFC words) is subjected to modulation for recording so that a second modulation-resultant signal is generated. During a known pre-recording procedure, a wobble 113 of a groove 129a in a first recording layer 123 is formed in accordance with the first modulation-resultant signal. Accordingly, the first modulation-resultant signal is recorded on the optical disc 100 as the wobble 113 of the groove 129a in the first recording layer 123. The first modulation-resultant signal is also called the first wobbling signal. During the known pre-recording procedure, a wobble 113 of a groove 129b in a second recording layer 126 is formed in accordance with the second modulation-resultant signal. Accordingly, the second modulation-resultant signal is recorded on the optical disc 100 as the wobble 113 of the groove 129b in the second recording layer 126. The second modulation-resultant signal is also called the second wobbling signal. Thus, by determining which of “110X0” and “001X0” a synchronization check format reproduced from the optical disc 100 corresponds to, it is possible to decide whether the currently-accessed recording layer is the first recording layer 123 or the second recording layer 126.

As understood from the above description, predetermined one of a synchronization check format of “110X0” and a synchronization check format of “001X1” is assigned to the first recording layer 123 while the other is assigned to the second recording layer 126. The predetermined one of a synchronization check format of “110X0” except the information bit and a synchronization check format of “001X1” except the information bit is defined as a first layer identification information piece assigned to the first recording layer 123 while the other is defined as a second layer identification information piece assigned to the second recording layer 126. Accordingly, the different layer identification information pieces are assigned to the first and second layers 123 and 126 respectively. The first layer identification information piece or the second layer identification information piece in each of CFC words indicates which of the first and second recording layers 123 and 126 the related word is assigned to.

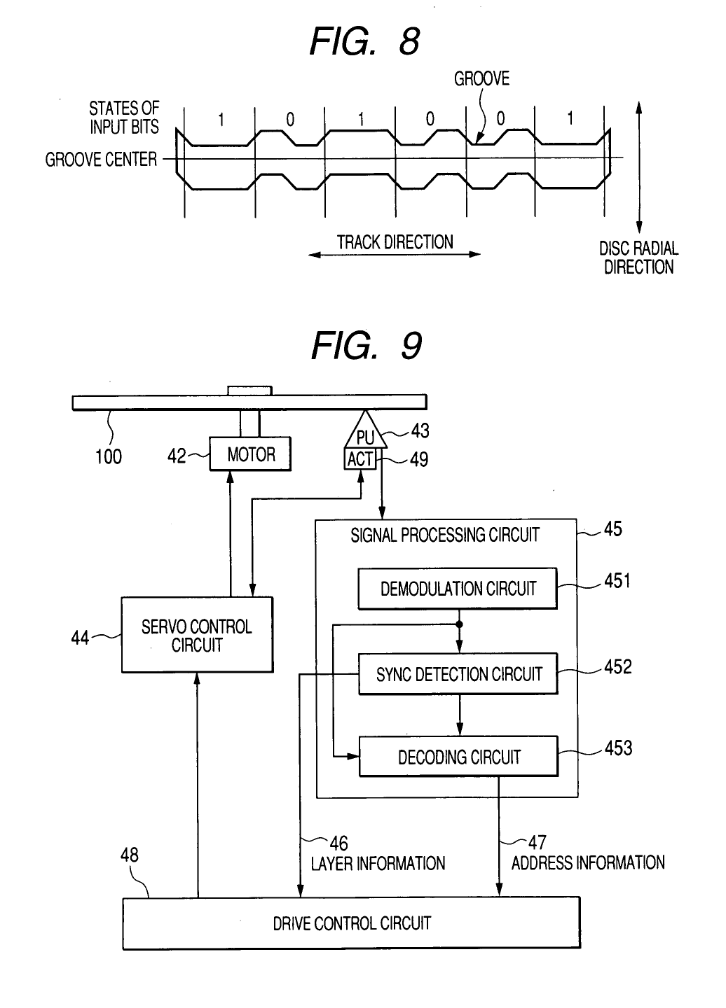

The recording modulation with respect to the first and second bit streams (the first and second successions of CFC words) is frequency modulation. Preferably, the recording modulation is bi-phase mark modulation. The wobbles 113 of the grooves 129a and 129b and the bi-phase mark modulation are designed as follows. Each of the wobbles 113 of the grooves 129a and 129b is divided into 1-bit portions, that is, portions corresponding to bits in an input bit stream respectively. As shown in FIG. 8, a 1-bit portion of each wobble 113 which is assigned to a bit of “0” in the input bit stream (the first or second bit stream, that is, the first or second succession of CFC words) has opposite shifts (displacements) at its starting point and its center point respectively. On the other hand, a 1-bit portion of each wobble 113 which is assigned to a bit of “1” in the input bit stream has a shift (displacement) at its starting point only. Here, “shift” means that the groove 129a or 129b falls into small misalignment with or slightly deviates from its average longitudinal center in a disc radial direction. The quantity of the shifts, that is, the degree of the misalignment, is set to a predetermined value such that interference can be prevented from occurring between neighboring groove portions as viewed in the disc radial direction, and that the wobbles 113 can be detected at a good S/N through the use of a tracking-related signal or a tracking error signal generated in an optical pickup.

As previously mentioned, by determining which of “110X0” and “001X1” a synchronization check format reproduced from the optical disc 100 corresponds to, a decision can be made as to whether the currently-accessed recording layer is the first recording layer 123 or the second recording layer 126. Therefore, without waiting for the completion of the recovery of the address information, it is possible to implement the decision on the currently-accessed recording layer by using the reproduced synchronization check format.

FIG. 9 shows an optical-disc drive apparatus in the first embodiment of this invention. The apparatus of FIG. 9 includes a spindle motor 42 having a rotary shaft on which the optical disc 100 is clamped. The optical disc 100 is rotated by the spindle motor 42. Rotation of the shaft of the spindle motor 42, that is, rotation of the optical disc 100, is controlled by a control signal fed to the spindle motor 42 from a servo control circuit 44.

The apparatus of FIG. 9 further includes an optical pickup 43 for applying a forward laser beam to the optical disc 100 and receiving a return laser beam therefrom. The optical pickup 43 converts the received laser beam into an electric signal. The optical pickup 43 outputs the electric signal. The optical pickup 43 is connected with actuators 49. The servo control circuit 44 supplies the actuators 49 with signals for control of the radial position of the optical pickup 43 relative to the optical disc 100 and focusing and tracking control of the forward laser beam with respect to the optical pickup 100. During a reproducing mode (a playback mode) and a recording mode of operation of the apparatus, control of the radial position of the optical pickup 43 and focusing and tracking control of the forward laser beam are implemented.

During the reproducing mode of operation of the apparatus, the optical pickup 43 focuses a forward laser beam of a constant reading intensity into a spot on either the first recording layer 123 or the second recording layer 126 in the optical disc 100. The diameter of the laser beam spot is slightly greater than the width of the grooves 129a and 129b in the optical disc 100. The forward laser beam is reflected substantially at the currently-accessed recording layer so that a return laser beam occurs. The return laser beam travels from the optical disc 100 to the optical pickup 43. The optical pickup 43 converts the return laser beam into an electric signal. The electric signal includes a wobbling signal reflecting the wobble 113 of currently-accessed one of the grooves 129a and 129b in the optical disc 100 and an information signal reflecting recorded marks 114 in the currently-accessed groove.

During the recording mode of operation of the apparatus, the optical pickup 43 focuses a forward laser beam of a recording intensity into a spot on either the first recording layer 123 or the second recording layer 126 in the optical disc 100. The forward laser beam carries an information signal to be recorded. The recording intensity is higher than the reading intensity. The forward laser beam makes recorded marks 114 in currently-accessed one of the grooves 129a and 129b in the optical disc 100. The recorded marks 114 reflect the information signal to be recorded.

A signal processing circuit 45 receives the electric signal from the optical pickup 43. The signal processing circuit 45 processes the received electric signal. The signal processing circuit 45 includes a demodulation circuit 451 for a wobbling signal, a sync detection circuit 452 for CFC words, and a decoding circuit 453 for address information.

The demodulation circuit 451 subjects a wobbling signal in the received electric signal to bi-phase mark demodulation to get a demodulation-resultant wobbling signal. The demodulation circuit 451 feeds the demodulation-resultant wobbling signal to the sync detection circuit 452 and the decoding circuit 453. The sync detection circuit 452 detects layer information (layer ID) 46 in the demodulation-resultant wobbling signal. The sync detection circuit 452 outputs the detected layer information (the detected layer identification information) 46 to a drive control circuit 48. The sync detection circuit 452 generates a sync detection signal from the demodulation-resultant wobbling signal. The sync detection circuit 452 outputs the sync detection signal to the decoding circuit 453. The decoding circuit 453 decodes address-related components of the demodulation-resultant wobbling signal into address information 47 in response to the sync detection signal. The decoding circuit 453 outputs the address information 47 to the drive control circuit 48.

Preferably, the drive control circuit 48 includes a combination of a processor and a memory storing a control program. The drive control circuit 48 or the processor operates in accordance with the control program. The control program is designed to enable the drive control circuit 48 to implement operation steps mentioned later. An example of the processor is a CPU.

The apparatus of FIG. 9 includes a sensor (not shown) for detecting the mounting of an optical disc 100 on the shaft of the spindle motor 42. The apparatus starts operating in a layer deciding mode when the sensor detects that an optical disc 100 is mounted on the shaft of the spindle motor 42.

During the layer deciding mode of operation of the apparatus, the drive control circuit 48 notifies a target on-disc address to the servo control circuit 44. The servo control circuit 44 controls the spindle motor 42 to rotate at a prescribed speed. The servo control circuit 44 controls the actuators 49 to move the optical pickup 43 radially of the optical disc 100 to a position corresponding to the target on-disc address. Then, the optical pickup 43 starts emitting a forward laser beam. The servo control circuit 44 controls the actuators 49 to provide proper focusing and tracking conditions of the forward laser beam with respect to the optical disc 100. At this time, it is difficult to decide which of the first and second recording layers 123 and 126 in the optical disc 100 the forward laser beam is currently focused on. The forward laser beam is reflected by the optical disc 100 so that a return laser beam occurs. The return laser beam travels from the optical disc 100 to the optical pickup 43.

The optical pickup 43 converts the return laser beam into an electric signal inclusive of a wobbling signal reflecting the wobble 113 of currently-accessed one of the grooves 129a and 129b in the optical disc 100. Generally, the wobbling signal is obtained as a tracking error signal. The optical pickup 43 feeds the wobbling signal to the signal processing circuit 45. The demodulation circuit 451 in the signal processing circuit 45 subjects the wobbling signal to bi-phase mark demodulation, thereby converting the wobbling signal into an original digital bit stream. The demodulation circuit 451 feeds the bit stream to the sync detection circuit 452 and the decoding circuit 453.

The demodulation circuit 451 includes a phase locked loop (PLL) circuit for generating a clock signal from the wobbling signal. The PLL circuit responds to time intervals between shifts in the wobbling signal, and thereby produces the clock signal synchronized with the boundaries between 1-bit periods. For every 1-bit period defined by the clock signal, the demodulation circuit 451 determines whether or not the corresponding portion of the wobbling signal has a shift at the center of the 1-bit period. The demodulation circuit 451 generates a demodulation-resultant bit of “1” for the portion of the wobbling signal which does not have a shift at the center of the 1-bit period. The demodulation circuit 451 generates a demodulation-resultant bit of “0” for the portion of the wobbling signal which has a shift at the center of the 1-bit period. The demodulation circuit 451 concatenates the demodulation-resultant bits into the bit stream.

The sync detection circuit 452 implements synchronization with CFC words in the bit stream from the demodulation circuit 451. The sync detection circuit 452 compares the synchronization check bit sequences (the synchronization check bit patterns or the synchronization check formats) with the bit stream for the implementation of the synchronization. In addition, the sync detection circuit 452 generates the layer identification information 46 from the bit stream through the use of the synchronization check bit sequences.

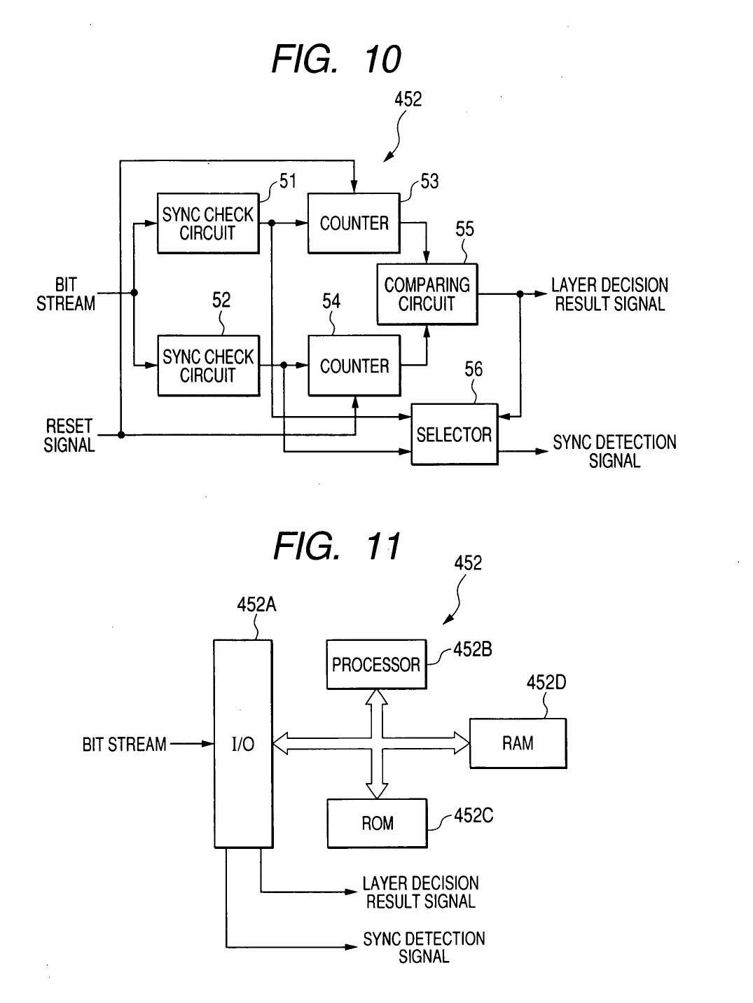

As shown in FIG. 10, the sync detection circuit 452 includes sync check circuits 51 and 52, counters 53 and 54, a comparing circuit 55, and a selector 56. The sync check circuits 51 and 52 receive the bit stream from the demodulation circuit 451. The sync check circuit 51 includes a memory storing a synchronization check bit pattern of “110X0” (in which check point bits represent a first layer identification information piece assigned to predetermined one of the first and second recording layers 123 and 126), and a comparator for comparing the synchronization check bit pattern with a current 5-bit portion of the bit stream which is periodically updated. When the synchronization check bit pattern and the current 5-bit portion of the bit stream match each other, the sync check circuit 51 outputs a hit signal to the counter 53 and the selector 56. Otherwise, the sync check circuit 51 outputs a non-hit signal to the counter 53 and the selector 56. The sync check circuit 52 includes a memory storing a synchronization check bit pattern of “001X1” (in which check point bits represent a second layer identification information piece assigned to the other of the first and second recording layers 123 and 126), and a comparator for comparing the synchronization check bit pattern with a current 5-bit portion of the bit stream which is periodically updated. When the synchronization check bit pattern and the current 5-bit portion of the bit stream match each other, the sync check circuit 52 outputs a hit signal to the counter 54 and the selector 56. Otherwise, the sync check circuit 52 outputs a non-hit signal to the counter 54 and the selector 56.

As previously mentioned, the wobble 113 of the groove 129a in the first recording layer 123 of the optical disc 100 is accorded with predetermined one of a synchronization check bit pattern of “110X0” and a synchronization check bit pattern of “001X1”. The wobble 113 of the groove 129b in the second recording layer 126 of the optical disc 100 is accorded with the other of a synchronization check bit pattern of “110X0” and a synchronization check bit pattern of “001X1”. Thus, in the case where the forward laser beam is focused on the first recording layer 123, one of the sync check circuits 51 and 52 periodically outputs a hit signal. In the case where the forward laser beam is focused on the second recording layer 126, the other of the sync check circuits 51 and 52 periodically outputs a hit signal. Accordingly, predetermined one of the sync check circuits 51 and 52 corresponds to the wobble 113 of the groove 129a in the first recording layer 123 while the other corresponds to the wobble 113 of the groove 129b in the second recording layer 126.

The counters 53 and 54 are associated with the sync check circuits 51 and 52, respectively. As previously mentioned, predetermined one of the sync check circuits 51 and 52 corresponds to the wobble 113 of the groove 129a in the first recording layer 123 while the other corresponds to the wobble 113 of the groove 129b in the second recording layer 126. Therefore, predetermined one of the counters 53 and 54 corresponds to the first recording layer 123 while the other corresponds to the second recording layer 126.

The counter 53 counts hit signals outputted from the sync check circuit 51. The counter 53 notifies the count number of hit signals to the comparing circuit 55. The counter 54 counts hit signals outputted from the sync check circuit 52. The counter 54 notifies the count number of hit signals to the comparing circuit 55.

The comparing circuit 55 calculates the difference between the count numbers notified by the counters 53 and 54. The comparing circuit 55 compares the calculated difference with a predetermined number equal to, for example, 10. When the calculated difference is equal to or greater than the predetermined number (for example, 10), the comparing circuit 55 generates and outputs a layer-decision-result signal in accordance with which of the count numbers notified by the counters 53 and 54 is greater by the predetermined number or more. The layer-decision-result signal represents which of the first and second recording layers 123 and 126 the forward laser beam is currently focused on, that is, which of the first and second recording layers 123 and 126 is currently accessed. In the case where the count number notified by the counter 53 is greater, the layer-decision-result signal represents that the forward laser beam is currently focused on one of the first and second recording layers 123 and 126 which corresponds to the counter 53 or that one of the first and second recording layers 123 and 126 which corresponds to the counter 53 is currently accessed. In the case where the count number notified by the counter 54 is greater, the layer-decision-result signal represents that the forward laser beam is currently focused on one of the first and second recording layers 123 and 126 which corresponds to the counter 54 or that one of the first and second recording layers 123 and 126 which corresponds to the counter 54 is currently accessed.

The selector 56 receives the layer-decision-result signal from the comparing circuit 55. The selector 56 selects one of the output signals from the sync check circuits 51 and 52 in response to the layer-decision-result signal, and passes the selected signal to the decoding circuit 453. Specifically, when the layer-decision-result signal indicates that the count number notified from the counter 53 is greater than that from the counter 54 by the predetermined number (for example, 10) or more, the selector 56 selects the output signal of the sync check circuit 51. The selected signal is composed of hit signals outputted from the sync check circuit 51. On the other hand, when the layer-decision-result signal indicates that the count number notified from the counter 54 is greater than that from the counter 53 by the predetermined number, the selector 56 selects the output signal of the sync check circuit 52. The selected signal is composed of hit signals outputted from the sync check circuit 52. The selected signal passed to the decoding circuit 453 is handled as a sync detection signal.

The signal processing circuit 45 includes a signal generator (not shown). The signal generator produces a reset signal when the comparing circuit 55 outputs a layer-decision-result signal. The signal generator applies the reset signal to the counters 53 and 54 so that the count numbers provided by the counters 53 and 54 are reset to 0.

The layer-decision-result signal is fed from the comparing circuit 55 to the drive control circuit 48 as the layer information (the layer identification information) 46. The drive control circuit 48 identifies the currently-accessed recording layer in the optical disc 100 by referring to the layer information 46. The drive control circuit 48 decides whether the identified currently-accessed recording layer is equal to or different from desired one of the first and second recording layers 123 and 126. When the identified currently-accessed recording layer is different from the desired one, the drive control circuit 48 drives and controls the actuators 49 through the servo control circuit 44 to focus the forward laser beam on the other of the first and second recording layers 123 and 126. When the identified currently-accessed recording layer is equal to the desired one, the drive control circuit 48 keeps the actuators 49 focusing the forward laser beam on the desired recording layer.

The comparing circuit 55 generates and outputs a layer-decision-result signal (layer information 46) provided that the difference between the count numbers notified by the counters 53 and 54 increases to or above the predetermined number, for example, 10. Accordingly, even in the event that a temporary demodulation error occurs in the demodulation circuit 451 and hence a wrong hit signal is outputted from the sync check circuit 51 or 52, the layer-decision-result signal is reliable.

The sync detection signal fed to the decoding circuit 453 from the selector 56 corresponds to the acquisition of synchronization with CFC words in the bit stream outputted from the demodulation circuit 451. The decoding circuit 453 divides the bit stream into CFC words in response to the sync detection signal. The decoding circuit 453 detects information bits D in every CFC word, and extracts the information bits D therefrom. Specifically, the decoding circuit 453 extracts 4 information bits D from every CFC word in FIGS. 6 and 7. The decoding circuit 453 periodically stores a prescribed number of extracted information bits D, and subjects the stored information bits D to error correction to recover address information 47 indicating a currently-accessed address on the optical disc 100. The prescribed number is determined by an address-recording and error-correction format for the address information recorded as the wobbles 113. The decoding circuit 453 feeds the recovered address information 47 to the drive control circuit 48.

The drive control circuit 48 compares the currently-accessed on-disc address and a desired on-disc address (a target on-disc address) to be accessed. When the currently-accessed on-disc address differs from the desired on-disc address, the drive control circuit 48 drives and controls the actuators 49 through the servo control circuit 44 to move the optical pickup 43 to a position corresponding to the desired on-disc address. Otherwise, the drive control circuit 48 holds the optical pickup 43 at its current position.

As previously mentioned, the optical disc 100 has the first and second recording layers 123 and 126. The on-disc address information is divided into information bits placed in CFC words falling into a first group assigned to the first recording layer 123 and a second group assigned to the second recording layer 126. Each CFC word has check point bits in either a first pattern or a second pattern. The CFC words assigned to the first recording layer 123 have the first check point bit pattern in common. The first check point bit pattern is called the first synchronization check bit pattern. On the other hand, the CFC words assigned to the second recording layer 126 have the second check point bit pattern in common. The second check point bit pattern is called the second synchronization check bit pattern. A first bit stream formed by a succession of the concatenated CFC words assigned to the first recording layer 123 is subjected to bi-phase mark modulation so that a first modulation-resultant signal is generated. During a known pre-recording procedure, the first modulation-resultant signal is recorded on the first recording layer 123 as the wobble 113 of the groove 129a therein. The bi-phase mark modulation causes the first bit stream to be expressed by the positions of shifts of the wobble 113 of the groove 129a. A second bit stream formed by a succession of the concatenated CFC words assigned to the second recording layer 126 is subjected to bi-phase mark modulation so that a second modulation-resultant signal is generated. During the known pre-recording procedure, the second modulation-resultant signal is recorded on the second recording layer 123 as the wobble 113 of the groove 129b therein. The bi-phase mark modulation causes the second bit stream to be expressed by the positions of shifts of the wobble 113 of the groove 129b.

The apparatus of FIG. 9 reproduces a wobbling signal from the wobble 113 of the groove in currently-accessed one of the first and second recording layers 123 and 126. The demodulation circuit 451 subjects the reproduced wobbling signal to bi-phase mark demodulation to get a demodulation-resultant bit stream. The sync detection circuit 452 makes a decision on a synchronization check bit pattern in the demodulation-resultant bit stream to determine which of the first and second recording layers 123 and 126 is currently accessed. The determination as to which of the first and second recording layers 123 and 126 is currently accessed can be implemented without waiting for the recovery of address information 47 from the demodulation-resultant bit stream. Accordingly, this determination can be promptly implemented. Thus, it is possible to shorten a time taken by the optical pickup 49 to access a desired position on the optical disc 100.

### SECOND EMBODIMENT

A second embodiment of this invention is similar to the first embodiment thereof except that the sync detection circuit 452 includes a computer.

As shown in FIG. 11, the computer in the sync detection circuit 452 has a combination of an input/output port 452A, a processor 452B, a ROM 452C, and a RAM 452D. The computer or the processor 452B therein operates in accordance with a control program stored in the ROM 452C or the RAM 452D. The input/output port 452A receives the bit stream from the demodulation circuit 451 (see FIG. 9). The input/output port 452A feeds the layer-decision-result signal, that is, the layer information 46, to the drive control circuit 48 (see FIG. 9). The input/output port 452A feeds the sync detection signal to the decoding circuit 453 (see FIG. 9).

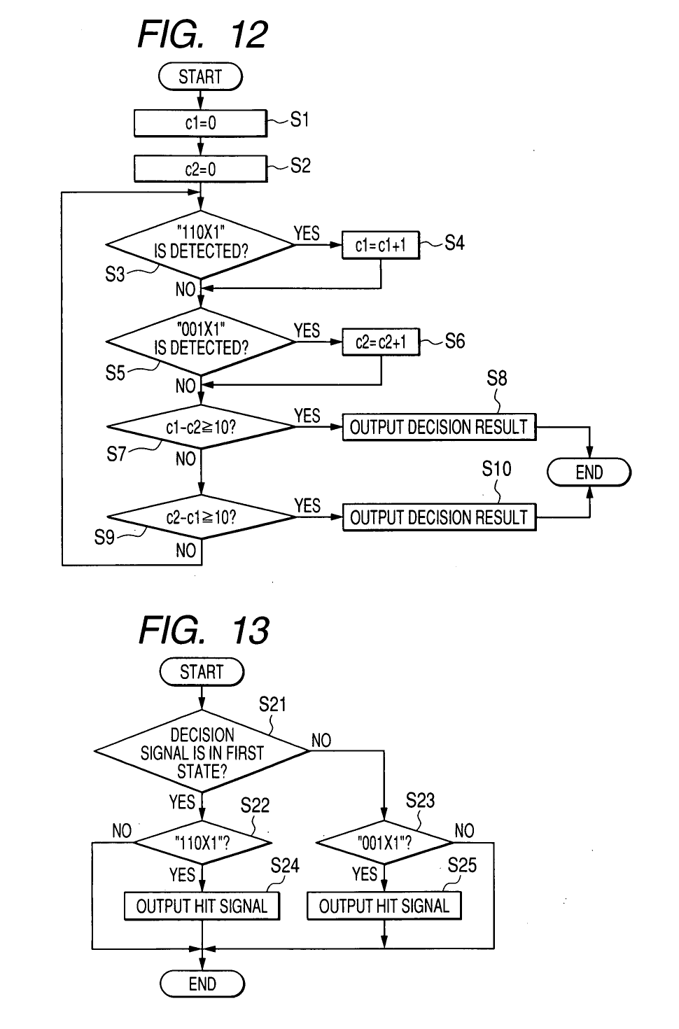

FIG. 12 is a flowchart of a first segment of the control program for the computer. As shown in FIG. 12, a first step S1 of the program segment initializes or resets a variable c1 to 0. The variable c1 indicates a count number.

A step S2 following the step S1 initializes or resets a variable c2 to 0. The variable c2 indicates another count number. After the step S2, the program advances to a step S3.

The step S3 compares a synchronization check bit pattern of “110X0” with a current 5-bit portion of the bit stream which is periodically updated. When the synchronization check bit pattern and the current 5-bit portion of the bit stream match each other, the program advances from the step S3 to a step S4. Otherwise, the program advances from the step S3 to a step S5.

The step S4 increments the count number c1 by 1. After the step S4, the program advances to the step S5.

The step S5 compares a synchronization check bit pattern of “001X1” with the current 5-bit portion of the bit stream. When the synchronization check bit pattern and the current 5-bit portion of the bit stream match each other, the program advances from the step S5 to a step S6. Otherwise, the program advances from the step S5 to a step S7.

The step S6 increments the count number c2 by 1. After the step S6, the program advances to the step S7.

The step S7 calculates the difference “c1−c2” equal to the count number c1 minus the count number c2. The step S7 compares the difference “c1−c2” with 10 (a predetermined number). When the difference “c1−c2” is equal to or greater than 10, the program advances from the step S7 to a step S8. Otherwise, the program advances from the step S7 to a step S9.

The step S9 calculates the difference “c2−c1” equal to the count number c2 minus the count number c1. The step S9 compares the difference “c2−c1” with 10 (the predetermined number). When the difference “c2−c1” is equal to or greater than 10, the program advances from the step S9 to a step S10. Otherwise, the program returns from the step S9 to the step S3.

The step S8 decides that the currently-accessed recording layer (the recording layer on which the forward laser beam is currently focused) is one storing a synchronization check bit pattern of “110X0”. The step S8 generates a layer-decision-result signal in accordance with the result of the decision. The generated layer-decision-result signal is in a first state. The step S8 outputs the layer-decision-result signal to the drive control circuit 48 (see FIG. 9) as the layer information 46. After the step S8, the current execution cycle of the first program segment ends.

The step S10 decides that the currently-accessed recording layer (the recording layer on which the forward laser beam is currently focused) is one storing a synchronization check bit pattern of “001X1”. The step S10 generates a layer-decision-result signal in accordance with the result of the decision. The generated layer-decision-result signal is in a second state differing from the first state. The step S10 outputs the layer-decision-result signal to the drive control circuit 48 as the layer information 46. After the step S10, the current execution cycle of the first program segment ends.

FIG. 13 is a flowchart of a second segment of the control program for the computer. The second program segment is executed after the layer-decision-result signal is generated by the first program segment. Furthermore, the second program segment is executed each time the current 5-bit portion of the bit stream is updated.

As shown in FIG. 13, a first step S21 of the second program segment decides whether or not the layer-decision-result signal is in the first state. When the layer-decision-result signal is in the first state, the program advances from the step S21 to a step S22. Otherwise, the program advances from the step S21 to a step S23.

The step S22 decides whether or not the current 5-bit portion of the bit stream is “110X0”. When the current 5-bit portion of the bit stream is “110X0”, the program advances from the step S22 to a step S24. Otherwise, the program exits from the step S22, and then the current execution cycle of the second program segment ends.

The step S24 outputs a hit signal to the decoding circuit 453 (see FIG. 9). The outputted hit signal forms a 1-period-portion of the sync detection signal. After the step S24, the current execution cycle of the second program segment ends.

The step S23 decides whether or not the current 5-bit portion of the bit stream is “001X1”. When the current 5-bit portion of the bit stream is “001X1”, the program advances from the step S23 to a step S25. Otherwise, the program exits from the step S23, and then the current execution cycle of the second program segment ends.

The step S25 outputs a hit signal to the decoding circuit 453 (see FIG. 9). The outputted hit signal forms a 1-period-portion of the sync detection signal. After the step S25, the current execution cycle of the second program segment ends.

The computer program may be loaded into the computer from a recoding medium. Alternatively, the computer program may be downloaded into the computer via a communication network.

### THIRD EMBODIMENT

A third embodiment of this invention is similar to one of the first and second embodiments thereof except that the bi-phase mark modulation concerning the wobbling signal is replaced by other modulation.

### FOURTH EMBODIMENT

A fourth embodiment of this invention is similar to one of the first and second embodiments thereof except that the recorded marks 114 are formed in not only the grooves 129a and 129b but also the lands 128a and 128b.

### FIFTH EMBODIMENT

A fifth embodiment of this invention is similar to one of the first and second embodiments thereof except that the recorded marks 114 are formed in the lands 128a and 128b rather than the grooves 129a and 129b.

What is claimed is:

1. An optical disc having a plurality of recording layers arranged in a laminate in a thickness-wise direction of the disc, the recording layers having tracks respectively, the tracks wobbling in accordance with wobbling signals respectively and thereby indicating the wobbling signals respectively, wherein the wobbling signals result from modulation of bit streams formed by sequences of concatenated fixed-length words of a predetermined self-synchronizable code, wherein each of the words is composed of check point bits and information bits, the check point bits representing a sync position and a layer identification information piece selected from different layer identification information pieces assigned to the recording layers respectively for indicating which of the recording layers the related word is assigned to, the information bits representing address information.

2. An optical disc as recited in claim 1, wherein the predetermined self-synchronizable code is a comma-free code of a prefix type.

3. A drive apparatus for an optical disc having a plurality of recording layers arranged in a laminate in a thickness-wise direction of the disc, the recording layers having tracks respectively, the tracks wobbling in accordance with wobbling signals respectively and thereby indicating the wobbling signals respectively, wherein the wobbling signals result from modulation of bit streams formed by sequences of concatenated fixed-length words of a predetermined self-synchronizable code, wherein each of the words is composed of bits including check point bits which represent a sync position and also a layer identification information piece selected from different layer identification information pieces assigned to the recording layers respectively for indicating which of the recording layers the related word is assigned to, the drive apparatus comprising:
an optical pickup for applying a forward laser beam to the optical disc and focusing the forward laser beam on one of the recording layers in the optical disc, and for receiving a return laser beam caused by reflection of the forward laser beam at the optical disc and converting the received return laser beam into an electric signal;
a demodulator for demodulating a wobbling signal in the electric signal into a reproduced bit stream formed by a sequence of concatenated fixed-length words of the predetermined self-synchronizable code;
first means for deciding a layer identification information piece represented by check point bits in the reproduced bit stream; and
second means for determining which of the recording layers the forward laser beam is currently focused on by referring to the layer identification information piece decided by the first means.

4. A drive apparatus as recited in claim 3, wherein the bits constituting each of the words include information bits representing address information, and further comprising third means for detecting information bits in the reproduced bit stream, and fourth means for recovering address information from the information bits detected by the third means.

5. A drive apparatus as recited in claim 3, wherein the predetermined self-synchronizable code is a comma-free code of a prefix type.

6. A method of making a decision on a currently-accessed recording layer in an optical disc having a plurality of recording layers arranged in a laminate in a thickness-wise direction of the disc, the recording layers having tracks respectively, the tracks wobbling in accordance with wobbling signals respectively and thereby indicating the wobbling signals respectively, wherein the wobbling signals result from modulation of bit streams formed by sequences of concatenated fixed-length words of a predetermined self-synchronizable code, wherein each of the words is composed of bits including check point bits which represent a sync position and also a layer identification information piece selected from different layer identification information pieces assigned to the recording layers respectively for indicating which of the recording layers the related word is assigned to, the method comprising the steps of:
applying a forward laser beam to the optical disc and focusing the forward laser beam on one of the recording layers in the optical disc;
receiving a return laser beam caused by reflection of the forward laser beam at the optical disc and converting the received return laser beam into an electric signal;
demodulating a wobbling signal in the electric signal into a reproduced bit stream formed by a sequence of concatenated fixed-length words of the predetermined self-synchronizable code;
comparing a periodically-updated current portion of the reproduced bit stream with the different layer identification information pieces to count, for each of the different layer identification information pieces, a number of times the current portion of the reproduced bit stream is equal to the present layer identification information piece;
detecting a greatest one among the count numbers for the different layer identification information pieces respectively, the greatest one being greater than a second greatest one by at least a predetermined value; and
deciding that the recording layer corresponding to the detected greatest one among the count numbers is the recording layer on which the forward laser beam is currently focused on.

7. A method as recited in claim 6, wherein the predetermined self-synchronizable code is a comma-free code of a prefix type.
